(19) United States
(12) Patent Application Publication
(10) Pub. No.: US 2024/0155198 A1
(43) Pub. Date: May 9, 2024

(54) METHOD FOR EVALUATING ARTISTIC PERFORMANCES AND CORRESPONDING SYSTEM

(71) Applicant: Mr. Sergio PORCELLINI, Torino (TO) (IT)

(72) Inventor: Sergio Porcellini, Torino (TO) (IT)

(21) Appl. No.: 18/550,542

(22) PCT Filed: Mar. 11, 2022
(86) PCT No.: PCT/IB2022/052216

§ 371 Date: Sep. 14, 2023

(30) Foreign Application Priority Data
Mar. 15, 2021 (IT) 102021000006116

(51) Int. Cl. H04N 21/4784; H04N 21/254; H04N 21/478

(52) U.S. Cl. CPC H04N 21/4784; H04N 21/2542; H04N 21/47815

(57) ABSTRACT

A method for evaluating artistic performances represented digitally, transmitted via multimedia supports over a communications network to an evaluation node which is being accessed by a set of users who constitute an audience for utilizing on payment, the digital artistic performance, includes: for a plurality of time periods of increasing length, executing a procedure of evaluation of artistic performances from among the artistic performances received in the time period, including: evaluating the artistic performances received in the time period to determine an orderly ranking according to a sum of times of utilization of each artistic performance by users who constitute the audience in said time period; associating an indication of value to the artistic performances that are at the top of the orderly ranking storing in a database said orderly ranking by storing the top artistic performance, its indication of value, and a temporal indication.

The present invention relates to a method for evaluating artistic performances, in particular artistic performances represented digitally, which are transmitted via multimedia supports over a communications network to an evaluation node in said communications network, said evaluation node being accessed by a set of users who constitute an audience so that they may utilize, for example view, in particular on payment, the digital artistic performance.

Such techniques are described herein with specific reference to the evaluation of artistic performances represented via digital images or videos, but may also refer to other types of works of art.

Known to the art are multiple systems, which have the purpose of enabling access for various reasons to mechanisms for awarding prizes, through evaluation of a given performance.

Frequently, mechanisms for awarding prizes, which normally refer to the context of games, but also competitions or contests, are associated to information-diffusion services, for example newspapers; in this way, the game or competition or contest for which prizes are awarded is made readily accessible to a large number of people, exploiting the wide circulation of the newspaper, and at the same time purchase of the newspaper itself is incentivized.

Access to prizes is more problematical in connection with distribution of services over telematic networks, i.e., telecommunications networks, such as the Internet, namely, awarding of prizes that are not the result of a draw, but are assigned through judgement on artistic performances, such as acts/works of art.

Reference is made herein, in particular, to the implementation of competitions where prizes are awarded which require a jury that makes an evaluation of the aforesaid artistic works.

Implementation on the Internet of such mechanisms of contests and competitions potentially enables participation of a very large number of competitors, several hundreds of thousands, or even millions, even in very limited time intervals, for example, of the order of minutes. Consequently, making an evaluation by a jury on a large number of works in a short time, assigning scores, and then identifying the winning works and competitors, as well as notifying the winners, is extremely problematical.

The object of the present invention is to provide a method of evaluation that will overcome the drawbacks referred to above by enabling management of evaluation of artistic works represented digitally, transmitted via multimedia supports over a communications network to an evaluation node of the aforesaid communications network.

According to the present invention, the above object is achieved thanks to a method for evaluating artistic works represented digitally, transmitted via multimedia supports over a communications network to an evaluation node in the aforesaid communications network, as well as thanks to a corresponding system that have the characteristics recalled specifically in the ensuing claims.

The invention will now be described with reference to the annexed drawings, which are provided purely by way of non-limiting example and in which:

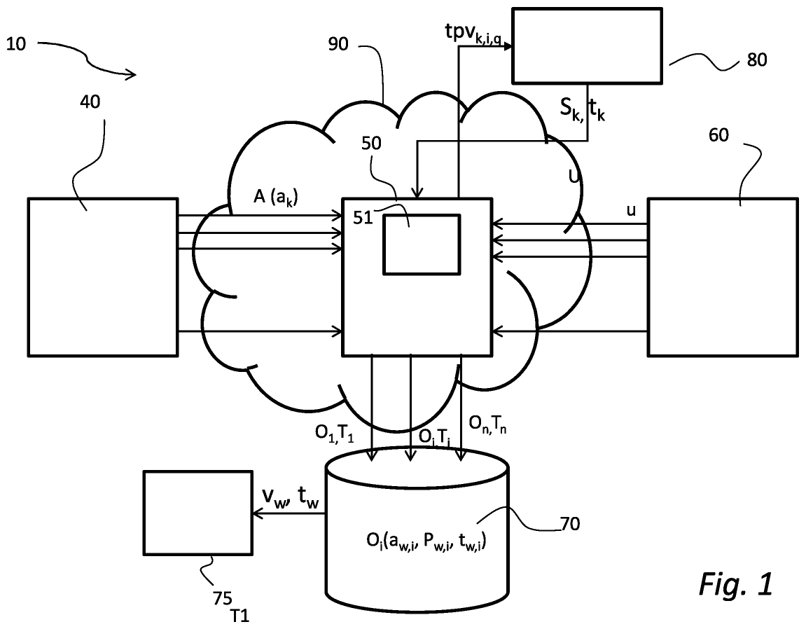

FIG. 1 is a block diagram of a system that implements the method according to the invention; and

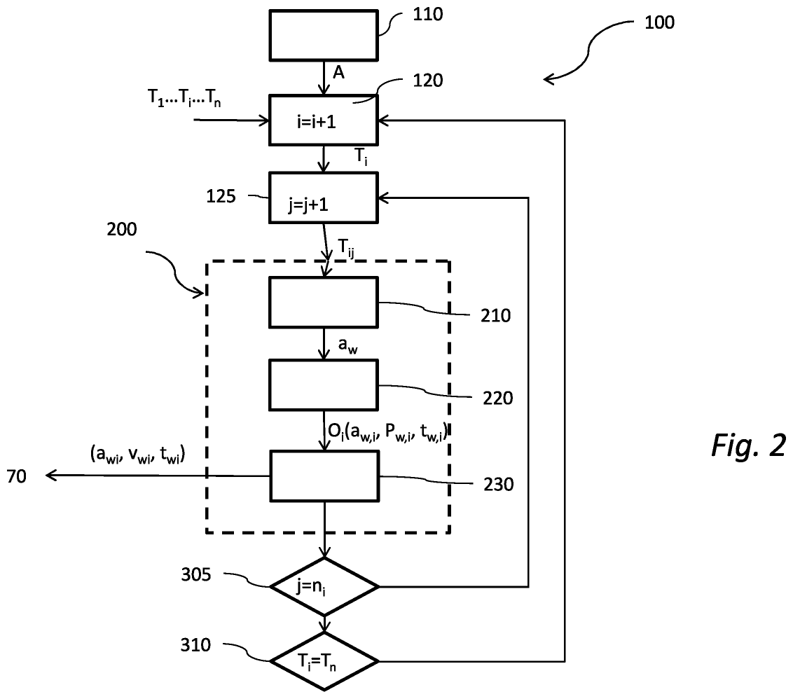

FIG. 2 represents a flowchart of the method according to the invention.

In brief, the solution according to the invention regards a method for evaluating artistic performances represented digitally, transmitted via multimedia supports over a communications network to an evaluation node in said communications network, said evaluation node being accessed by a set of users who constitute an audience so that they may utilize, in particular on payment, the digital artistic performance,
said method comprising the operations of:
given a plurality of time periods of increasing length, in particular any one length being a multiple of the other,
for each given time period in said plurality of time periods of increasing length,
executing a procedure for evaluating said artistic performances from among the artistic performances received in said given time period,
said evaluation procedure comprising the steps of:
evaluating said artistic performances received in the given time period to determine a corresponding orderly ranking according to a sum of times of utilization of each artistic performance by users who constitute the audience in said time period;
associating an indication of value to one or more of the artistic performances that are at the top in said orderly ranking, said indication being a function of the corresponding sum of utilization times;
storing in a database said orderly ranking by storing the top artistic performance or a given number of top artistic performances, the corresponding indication of value, and a temporal indication representing the time period to which said indication of value is referenced; and
periodically repeating said steps a), b), and c) on the works received in successive intervals equal to said given time period.

FIG. 1 is a schematic block diagram of a system implementing the method according to the invention, designated as a whole by the reference number 10.

Designated by 40 is a set of competitors who perform artistic performances—for example pieces of music or music videoclips, or documentary films, or artistic films, or narrative films, or static images, which may be digital creations or digital photographs of actual works, designated as a whole by A—the generic performance being instead designated by aₖ, where k (integer value) is the index of the performance received and made available for access to an evaluation node 90 as explained hereinafter and ranges, for example, from 1 to K. Hence, A is the set of the performances a₁, . . . , aₖ, . . . , a_{K}, which are represented digitally, for example via filming with a camera, and are transmitted through a telecommunications network, in the example the Internet, 90, to an evaluation node 50, for example hosted on a server computer. These different works aₖ may be performed in a plurality of different physical places, for example on actual stages. The number of works aₖ is high, meaning thereby a number K that may range, for example, from hundreds to thousands of works. It is emphasised how the distribution, in particular the geographical distribution, of the actual stages is difficult to foresee, as likewise the number K of the works. According to one embodiment, for the set 40 of competitors access is provided to a dedicated platform on a server connected to the telecommunications network 90, which provides an automatically organized schedule, useful in particular to the competitors who participate as amateurs and/or as occasional performers.

According to one aspect of the solution described herein, a maximum duration of the works A may be defined, for example 15 minutes.

For instance, it is envisaged that the works A are repeated fifteen times a day.

Designated by 50 is an evaluation node, implemented via one or more computers or a system of computers, which is configured for making an evaluation, receiving at the node 50 the set A of the multimedia works in digital format transmitted over the telecommunications network 90 to said evaluation node 50, according to a plurality of given time periods T₁, . . . , Tᵢ, . . . , Tₙ of increasing length, in particular any one length being a multiple of the other. The index i indicates the position of the period Tᵢ in the sequence of increasing duration and ranges from 1 to n, where n is an integer. For instance, a first period T₁ in the above plurality lasts 15 minutes, a second period T₂ 15 hours, a third period T₃ 15 days, a fourth period T₄ 15 weeks, a fifth period T₅ 15 months. Preferably, these given time periods T₁, . . . , Tᵢ, . . . , Tₙ of increasing length are each contained in the next interval; i.e., one or more intervals T₁ of 15 minutes are contained in the next interval T₂ of 15 hours (hence up to a maximum of sixty intervals T₁), in particular starting from one and the same starting instant.

The above evaluation procedure, which is more clearly represented by the reference 200 in the flowchart of FIG. 2, determines, for each time period Tᵢ, a corresponding ordering or ranking Oᵢ of the works aₖ received and made available to the audience 60 in the corresponding given time period Tᵢ, for example the first period T₁. This ordering or ranking Oᵢ, as explained more clearly in what follows, is a function of a total utilization time Sₖ, which is the sum of times tpv of utilization of the work aₖ by users u₁, . . . , u_{q}, . . . , u_{Q} belonging to an audience 60 that accesses the evaluation node 50.

In this regard, the evaluation node 50 is configured for measuring each time tpv of utilization of a given work aₖ by a user u_{q}, for example by measuring the time of streaming of the given work aₖ to the aforesaid user u_{q}. If the utilization time tpv, for example the time of viewing, is on a payment basis, i.e., the user u_{q} pays an amount for example proportional to the utilization time tpv, the amount of the payment may be acquired as measurement of the utilization time tpv.

The system for evaluating artistic performances 10 further comprises a node for recording utilization times 80, which may represent a computer, or a system of computers, and which is configured for receiving the values of the times tpv of utilization of the various works aₖ from the evaluation node 50 in the time periods Tᵢ and for recording them for each work aₖ in a set of utilization times that is associated to the respective work aₖ. The node for recording utilization times 80 is thus configured for supplying to the evaluation node 50 said set of utilization times and/or for evaluating for each set a total utilization time Sₖ together with a temporal indication tₖ of the complete recording of the set of times tpv associated to said work received aₖ, or preferably of the evaluation, of the aforesaid total utilization time Sₖ. In particular, as described in what follows, the node for recording utilization times 80 represents a system of computers that implements blockchain data structures, writing the utilization times tpv in blocks of blockchain structures BCₖ associated to the works aₖ and associating the timestamp of closing of the block to the set of utilization times written therein or to their sum, namely, the total utilization time Sₖ. Consequently, grouping into sets is carried out by writing, in particular, the utilization times tpv in the block associated to a period Tᵢ of a blockchain data structure BCₖ associated to the work aₖ, whereas the timestamp of the block determines a temporal indication tₖ of the complete recording that corresponds to closing of the block of the blockchain BCₖ. The total utilization time Sₖ may be calculated, for example at the node for recording utilization times 80, and written in the corresponding blockchain BCₖ, which is then read or received by the node 50, or calculated by the node 50 on the basis of the utilization times tpv for a given work in a given time period, which are read or received by the node for recording utilization times 80.

The works aₖ, ordered, in the ranking Oᵢ, on the basis of the respective total utilization time Sₖ, may be in total up to the number K of works made available to the evaluation node 50 in the time interval Tᵢ. Preferably, the evaluation procedure is configured for associating at least a corresponding economic value P_{w} to the work aₖ that takes first place in the ranking Oᵢ, i.e., a winning work a_{w}, where w is the value of the index k of the winning work a_{w} in the set a₁, . . . , aₖ, . . . , a_{K}, or else for associating even p values of economic value P_{w}, P_{w2}, . . . , P_{wp} where w, w2, wp are the values of k of the top p works in decreasing order in the ranking Oᵢ (P_{w}=P_{w1}). For instance, a ranking Oᵢ, with K=5, of the works received a₁, a₂, a₃, a₄, a₅ could be an orderly list of works a₃, a₄, a₁, a₅, a₂ associated to which are the respective total times S₃, S₄, S₁, S₅, S₂. The winning work a_{w} is a₃ (in the example w=3), or else if, for example p=3, the winning works are a₃, a₄, and a₁.

Albeit not indicated for simplicity in FIG. 1, economic values P_{w,1}, P_{w,2}, . . . , P_{w,i}, . . . , P_{w,n} are present in the case where an economic value is assigned to each period T₁, T₂, . . . , Tᵢ, . . . , Tₙ, respectively. The economic values P_{w,1}, P_{w,2}, . . . , P_{w,i}, . . . , P_{w,n} have an increasing value, preferably a value strictly increasing in a monotonic way.

It is moreover clear that preferably each next time period Tᵢ₊₁ is a multiple in duration, according to a respective multiple nᵢ, of the previous one Tᵢ, and consequently the evaluation node 50 is configured for associating nᵢ values P_{1,i,j}, in the nᵢ periods Tᵢⱼ with j=1, . . . , nᵢ, and the value P_{1,i+1} when the next time period Tᵢ₊₁ elapses, to all the performances, or works, aₖ, received and made available to the audience 60 in the nᵢ periods Tᵢⱼ contained in the next period Tᵢ₊₁. It is moreover clear that, in variant embodiments, the next periods Tᵢ₊₁ may even be only longer than, but not multiples of, the period Tᵢ, the evaluation made by the node 50 leading to associating values P_{1,i} for the periods Tᵢ only to a part of the works received in the next and longer period Tᵢ₊₁. It may be noted that the number K of a₁, . . . , aₖ, . . . , a_{K} works received in the different periods Tᵢ may vary, so that K may not be constant in the different periods Tᵢ; i.e., it may vary according to the index i, K(i).

According to a main aspect of the solution, the rankings Oᵢ corresponding to the first work or the first p works ranked, i.e., the works ranked from the first to the p-th, are stored in a database 70. Each record of the database 70 comprises, for example, a work, for instance a₃, ranked among the first places or in the first place, for example stored as multimedia file as received at the node 50, the time period Tᵢ in which the evaluation has been made, the indication of value P₁, and temporal information t_{w} corresponding to the timestamp ts_{w}—where w is the value of the index k of the winning work a_{w}, in the example w=3, of the block of the blockchain structure stored in which is the sum of times Sₖ that corresponds to the winning work, i.e., in the example in question, S₃.

As has been said, the evaluation node 50, receives the works aₖ, recorded live, for example, by cameras and sound-recording apparatuses on the actual stages, or else collected even only on digital multimedia supports, such as MPEG, MP3, or JPEG files, through the telecommunications network 90.

According to a preferred embodiment, as already mentioned, it is envisaged that access to the works aₖ received in a given time period Tᵢ will be enabled, in the same given time period Tᵢ, for utilization by an audience, designated as a whole by 60 and formed, for example, by a number Q of users who constitute the audience uᵢ, . . . , u_{q}, . . . , u_{Q}, which connect up to the node 50 through respective terminals operating on the network 90.

According to a further aspect of the solution described herein, the rankings Oᵢ in the various time periods Tᵢ are stored in the database 70.

The database 70 may, for example, be used for commercial management, by an agency 75 or body, of the performance a_{w} ranked first, stored in the aforesaid database. Such commercial management is performed, for example, in relation to the market, logistics, work, private and public insurance for all the artists who are the authors of the performances, and comprises the possibility for the agency 75 to access a certification of value v_{w} in the aforesaid database 70, which corresponds to an indication, or assignment, of a value P_{w,i} in an interval Tᵢ or to a sum of indications P_{w,i} on a number of intervals Tᵢ that follow one another (not necessarily in a consecutive way), which may be stored together with the performance a_{w} and with a temporal certification corresponding to the temporal information t_{w}, in particular corresponding to the last indication of value recorded in the database 70 for that performance, in such a way that the agency 75 will have available a certified value v_{w} of the performance, which is certified in its initial value P_{w} and in its increments in time, due, for example, to the ranking as the first or among the first in the successive rankings Oᵢ.

The period Tᵢ of assignment of the values P_{w,i} corresponds to a time interval that is used, through the timestamp ts_{w}—which is, for example, the closing timestamp of a block of the blockchain, as illustrated hereinafter—as certification of the date and time of assignment of the value P_{w,i} itself, through a timestamping procedure according to the ISO 8601 standards, contained in the blockchain associated to the performance.

The initial indication of value P_{w} of the performance a_{w} ranked as first or among the first stored in the database 70 increases in time if the performance a_{w} in question is among the performances to which economic values P_{w} are assigned also in one or more of the subsequent time periods having a length that is a multiple of the current period or greater. In this way, the certified value v_{w} of the performance, which is obtained as a sum or combinations is determined, certified, and stored.

Consequently, shown in FIG. 2 is a flowchart representing an embodiment of the method for evaluating artistic performances A represented digitally and transmitted, via multimedia supports, over the communications network 90 to the evaluation node 50 implemented by the system 10 of FIG. 1, the method being designated as a whole by the reference 100.

The above method 100 comprises an operation, designated by 110, of receiving the performances A contained in multimedia supports transmitted over a telecommunications network, in particular the Internet, to said evaluation node 50.

Hence, given the plurality T₁, . . . , Tᵢ, . . . , Tₙ of time periods of increasing length, in particular any one length being a multiple of the other, the method envisages:
for each given time period Tᵢ of said plurality Tᵢ, . . . , Tᵢ, . . . , T₁, of time periods of increasing length, the corresponding cycle being designated by 120,
carrying out a procedure 200 of evaluation of said performances A from among the performances received a₁, . . . , aₖ, . . . , a_{K} in said given time period Tᵢ.

The above evaluation procedure 200 comprises a first step 210 of evaluating the performances A, i.e., aₖ, received in the time period T₁ (or in the generic i-th period Tᵢ) to determine a corresponding orderly ranking O₁ (in general, O₁) as a function of a sum of the times tpv of utilization of each artistic performance aₖ by users who constitute the audience 60 in said time period T₁. It may be noted that, if k is the index of the performance, i is the index of the period, and q is the index of the user from among the users who utilize the digital performance in question, each utilization time will be tpv(k,i,q) or tpv_{k,i,q}; i.e., the individual utilization time is identified by at least said three indices, but for simplicity in what follows it is denoted only as tpv.

In the above operation 210, it is envisaged to associate, to each performance aₖ received, a respective blockchain structure BCₖ. In this blockchain structure BCₖ each time of utilization on payment tpv measured in the time interval or period T₁ is written in the blockchain as transaction in a block of the blockchain. Consequently, at the end of the first interval T₁, the blockchain BCₖ associated to a given performance aₖ comprises a sequence of blocks, each comprising a transaction, i.e., a time of utilization on payment, with the corresponding timestamp that indicates generation of the block. At the end of the interval T₁, access is allowed to the blockchains BCₖ associated to the performances aₖ to read the times tpv and determine a ranking of the interval T₁ that is based upon the sum Sₖ of the times in each blockchain BCₖ. Specifically, in each block of a blockchain BCₖ the value of time of viewing on payment tpv is read, the sum Sₖ of all the utilization times, in particular the times of viewing on payment tpv, is made for a given blockchain BCₖ associated to a given performance aₖ, the sums Sₖ for all the blockchains BCₖ, i.e., for all the corresponding performances aₖ in the period T₁ are ordered according to the value, preferably starting from the sum with highest value to the sum with lowest value.

With reference to the diagram of FIG. 1, the node for recording utilization times 80 is configured to manage the blockchain data structures, receiving the times tpv to be written in the respective blocks of the respective blockchains BCₖ and returning, for example to the node 50, the sums Sₖ, each with corresponding timestamp that indicates generation of the block and provides the temporal indication tₖ of complete recording of the set of times tpv associated to said performance aₖ received. As has been said, the node 50 can also read the times tpv recorded in the blocks and calculate the sums Sₖ.

The utilization time tpv may also be paid with an amount in crypto-currency—i.e., a currency such as Bitcoin in turn associated to a blockchain—proportional to the aforesaid utilization time, for example a fixed amount for a utilization time tpv of given duration. The transaction written in the block of the blockchain BCₖ may be referenced to the transaction written in the blockchain of the above crypto-currency. In other words, the time tpv of utilization of a given performance can be counted starting from the transactions of crypto-currency that pay for the aforesaid utilization time tpv.

In variant embodiments, the utilization times tpv for a given performance are gathered as respective transactions at one of the nodes that implement the consensus mechanism of the blockchain structure, grouped together at the end of the period T₁, possibly also their sum being calculated over the period T₁. Then, the times tpv and/or their sum are/is written in a respective block of the blockchain, a timestamp tsp being associated to this writing operation.

It is then envisaged to associate 220 an indication of value P_{w,i} to the performance in first place in the ranking O₁ (in general, P_{w,i} for the ranking Oᵢ) or respective indications of value P_{w}, P_{w1}, . . . , P_{wp} to the first p performances, which may even be all the performances in the ranking. This indication of value P_{w} for a given performance a_{w} that is ranked first is, for example, a function of the above sum of the times Sₖ; for example, it is a fraction of the sum of the times Sₖ multiplied by the utilization cost per unit time, for example 0.2 Euro per minute. Thus, by way of example, there can be a direct proportionality, or another relation which maintains the monotony of the ranking. In the subsequent periods of time it is possible to introduce multipliers having a value that is, for example, greater in order to increase the value P_{w,1}, for instance in a way proportional to the duration of the time period Tᵢ, as has been mentioned previously.

It is then envisaged to store, in a subsequent step 230, the above ranking O₁ in the database 70, indicating for each performance the aforesaid value P_{w,i} and a timestamp t_{w,i} of the last block, corresponding to the last transaction/utilization time for the given time period Tᵢ. Preferably, also identification parameters are indicated, which enable access to reading of the blocks of the corresponding blockchain BCₖ.

The operation of association of an indication of value P_{w,i} may comprise authorization by the evaluation node 50 of a payment to the performers of the performance aₖ corresponding to the above indication of value P_{w,i} as a prize and/or as a payment for the purchase of the rights of the performance. Furthermore, a payment, i.e., a fraction, generally smaller than the amount paid to the authors of the performance, based upon the above indication of value, may also be made to the set of users who have determined the utilization times of a performance ranked among the winners of prizes.

In subsequent (longer) intervals, the operation is repeated, so that, in the database, for each performance a_{w} that is numbered among the ones associated to which is an indication of value in the various intervals, different value-timestamp pairs are associated, which cumulatively define a value of the performance, which depends upon a quantity, the utilization times, that is certified in the corresponding blockchain.

Hence, advantageously, the method proposed enables association of a certified value based upon the utilization times of the performance, which enables mechanisms for awarding prizes, or for payment, or for attribution of a value to a digital work.

Once the procedure 200 is through, in step 310 a check is made as to whether the entire sequence of periods T₁, . . . , Tᵢ, . . . , Tₙ has been exhausted. If it has not, control returns to step 120, which increments the index i in order to repeat the operations 210-230 on the performances received in the time periods subsequent to the current time period Tᵢ.

It should be noted that, since there are usually nᵢ*Tᵢ periods contained in the duration of the next period Tᵢ₊₁, to take this into account, there is used, as illustrated in FIG. 2, a period indexed as Tᵢⱼ, with j=1, . . . , nᵢ, and, in a step 305 prior to step 310, it is optionally envisaged to check whether the index j is less than nᵢ. If it is, control passes to a step 125, where the index j is incremented by 1. In other words, it is envisaged to execute the procedure 200 for all the periods Tᵢ contained in the next period Tᵢ₊₁, assigning respective indications of value that can be denoted by P_{wi,j}, and then pass to the evaluation procedure 200 for the next period Tᵢ₊₁, assigning the value P_{wi+1,j}, starting from j=1. When j=nᵢ, there will be assigned both the value for the last repetition of the period Tᵢ and the value for the first repetition of the next period Tᵢ₊₁.

In embodiments, the described method for evaluating artistic performances A, in particular artistic performances represented digitally, transmitted via multimedia supports over a communication network 90 to an evaluation node 50 in said communication network, said evaluation node 50 being accessed by a set of users who constitute an audience 60 for utilizing, in particular on payment, artistic performances A, in particular digital artistic performances, comprises the operations of:
given a plurality, by way of example T₁, . . . , Tₙ, of time periods of increasing length, in particular any one length being a multiple of the other, for each given time period, e.g., Tᵢ, in said plurality, e.g., T₁, . . . , Tₙ of time periods of increasing length,
executing, in particular at said evaluation node 50, an evaluation procedure 200 on the artistic performances received in said given time period Tᵢ,
said evaluation procedure 200 comprising the steps of:
a) evaluating 210 said artistic performances A received in the time period, e.g. Tᵢ, to determine a corresponding orderly ranking (Oᵢ) as a function of a sum Sₖ of utilization times tpv of each artistic performance aₖ by users who constitute the audience 60 in said time period Tᵢ, in particular said utilization times tpv being measured by the evaluation mode 50 and the sum Sₖ of utilization times being calculated at a node for recording utilization times 80 on the basis of utilization times, e.g., tpv, received by said evaluation node 50, and supplied then to said evaluation node 50 or said evaluation node 50 receiving the utilization times tpv and calculating the sum Sₖ;
b) associating, in particular at said evaluation node 50, an indication of value P_{w} to a top artistic performance a_{w} or to a given number of top artistic performances in said orderly ranking Oᵢ, such indication being a function of the corresponding sum Sₖ of utilization times tpv; and
c) storing 230 in a database 70 said orderly ranking Oᵢ by storing the top artistic performance a_{w} or a given number of top artistic performances, the corresponding indication of value, and a temporal indication t_{w} representing the time period Tᵢ to which said indication of value P_{w} is referenced;
   repeating, in particular periodically, said steps a), b) and c) on artistic performances received in successive time intervals equal to said given time period, e.g. Tᵢ, which are in particular comprised in the next time period, e.g., Tᵢ₊₁.

The node for recording utilization times 80 as mentioned is representative of a computer or of a system of computer which implements blockchain data structures, writing the utilization times tpv in blocks of blockchain structures BCₖ associated to the performances aₖ and associating the timestamp of the closure of the blocks to the group of utilization times written in it or to their sum, total utilization time Sₖ.

As described, thus, such operation of evaluating 210 in embodiments comprises
associating to each artistic performance aₖ received a respective blockchain data structure BCₖ, wherein each time of utilization on payment measured in the time period Tᵢ is written as transaction in a block of said blockchain data structure BCₖ, this thus in particular in the node for recording utilization times 80 which implements blockchain data structures, writing the utilization times tpv in blocks of blockchain data structures BCₖ associated to the performances aₖ and associating the timestamp of closure of the blocks to the group of utilization times written in it or to their sum, total utilization time Sₖ,
as well as accessing, at the end of the time period, e.g., Tᵢ, the respective blockchain data structures BCₖ in the node for recording 80, associated to the performances aₖ to determine a ranking of the time period Tᵢ based upon the sum Sₖ of times of utilization tpv of each artistic performance aₖ by users who constitute the audience (60) in said time period Tᵢ written in each blockchain (BCₖ).

Such an operation of accessing comprises that the evaluation node 50 reads or receives the utilization times or the sum somma Sₖ from the node for recording utilization times 80.

From the foregoing description, the solution described and the advantages afforded thereby hence emerge clearly.

The method described enables evaluation of a large number of performances that are performed in a relatively limited period of time via the adoption of a mechanism of automatic evaluation based upon the times of viewing, in particular upon payment, and of assignment thereto of an indication of value, which is associated to a certified time during which the aforesaid indication of value is attributed. The indication of value can be used for different purposes; i.e., it may possibly result in a corresponding or proportional prize to the performer, or else in a payment, or else also in a reference value base for calculating a value of purchase of the digital performance. The indication of value thus generated at the same time also determines a certification of value, via the use of a blockchain-based system, which provides data that can be stored, together with the artistic performance and a temporal certification, in an archive, such as a digital database, so that a subject which is interested to obtain payment, prizes, or purchase, or else a body for managing the commercial aspects inherent in the performance, may use as a base a certified value, i.e., a value that is certified as regards its initial value and as regards its increments.

1. A method for evaluating artistic performances (A) transmitted via multimedia supports over a communications network (90) to an evaluation node (50) in said communications network, said evaluation node (50) being accessed by a set of users who constitute an audience (60) for utilizing, on payment, artistic performances (A), said method comprising the operations of:
given a plurality (Tᵢ, . . . , Tₙ) of time periods of increasing length, wherein any one length being a multiple of the other, for each given time period (Tᵢ) in said plurality (T₁, . . . , Tₙ) of time periods of increasing length,
executing an evaluation procedure (200) on the artistic performances received in said given time period (Tᵢ), said evaluation procedure (200) comprising the steps of:
a) evaluating (210) said artistic performances (A) received in the time period (Tᵢ) to determine a corresponding orderly ranking (Oᵢ) as a function of a sum (Sₖ) of utilization times (tpv) of each artistic performance (aₖ) by users who constitute the audience (60) in said time period (Tᵢ);
b) associating an indication of value (P_{w}) to a top artistic performance (a_{w}) or to a given number of top artistic performances in said orderly ranking (Oᵢ), said indication being a function of the corresponding sum (Sₖ) of utilization times (tpv); and
c) storing (230) in a database (70) said orderly ranking (Oᵢ) by storing the top artistic performance (a_{w}) or a given number of top artistic performances, the corresponding indication of value, and a temporal indication (t_{w}) representing the time period (Tᵢ) to which said indication of value (P_{w}) is referenced;
repeating, said steps a), b) and c) on artistic performances received in successive time intervals equal to said given time period (Tᵢ), which are a comprised in a next time period (Tᵢ₊₁) of the plurality of time periods.

2. The method according to claim 1, wherein said evaluating (210) comprises:
associating to each artistic performance (aₖ) received a respective blockchain data structure (BCₖ), wherein each time of utilization on payment measured in the time period (Tᵢ) is written as a transaction in a block of said blockchain data structure (BCₖ); and
accessing, at an end of the time period (Tᵢ), respective blockchain data structures (BCₖ) associated to the artistic performances (aₖ) to determine a ranking of the time period (Tᵢ) based upon the sum (Sₖ) of utilization times (tpv) of each artistic performance (aₖ) by users who constitute the audience (60) in said time period (Tᵢ), said sum (Sₖ) of utilization times written in each blockchain data structure (BCₖ).

3. The method according to claim 2, wherein said evaluating (210) comprises reading in each block of the blockchain data structure (BCₖ) the value of utilization time (tpv), making the sum (Sₖ) of all the utilization times (tpv) of a given blockchain data structure (BCₖ) associated to a given artistic performance (aₖ), ordering the sums (Sₖ) of all the utilization times for all the blockchain data structures (BCₖ) over the time period (Tᵢ) according to their value of utilization time.

4. The method according to claim 2, wherein said operation of associating (220) an indication of value (P_{w}) to the top artistic performance or to the given number of the top artistic performances in the orderly ranking is a function of said sum (Sₖ) of utilization times (tpv) of each artistic performance (aₖ) by users who constitute the audience (60) in said time period (Tᵢ).

5. The method according to claim 2, wherein said operation of storing (230) said orderly ranking in the database (70) comprises storing for each artistic performance said indication of value (P_{w}), a timestamp of a last block corresponding to a last transaction or utilization time for the given time period, and identifying parameters that enable access to reading of the blocks of the blockchain structure (BCₖ).

6. The method according to claim 1, comprising executing said evaluation procedure (200) for all the time periods (Tᵢ) contained in the next time period (Tᵢ₊₁), assigning respective indications of value (P_{wi,j}), and then passing to execution of said evaluation procedure (200) for the next period (Tᵢ₊₁), assigning the indication of corresponding value (P_{wi+1,j})

7. The method according to claim 5, wherein each record of the database (70) comprises the top artistic performance (a_{w}) stored as multimedia file, the time period (Tᵢ) on which the evaluation (210) is made, the indication of value (p_{w}) assigned as a prize, and the temporal indication (t_{w}) corresponding to the timestamp (ts_{w}).

8. A system for evaluating artistic performances transmitted via the multimedia supports over the communications network (90) to the evaluation node (50) in said communications network (90), wherein the system is configured for executing the operations of the method according to claim 2.

9. The system according to claim 8, comprising one or more computers, (80) separated from said evaluation node, (50) for recording the utilization times (tpv) in blocks of said blockchain data structures (BCₖ).

10. The system according to claim 8, wherein said telecommunications network (90) is the Internet.
